(19) United States
(12) Patent Application Publication
(10) Pub. No.: US 2013/0104207 A1
(43) Pub. Date: Apr. 25, 2013

(54) Method of Connecting a Mobile Station to a Communcations Network

(71) Applicants: Dirk Kroeselberg, Munchen (DE); Maximilian Riegel, Nurnberg (DE)

(72) Inventors: Dirk Kroeselberg, Munchen (DE); Maximilian Riegel, Nurnberg (DE)

(73) Assignee: Nokia Siemens Networks Oy, Espoo (FI)

(21) Appl. No.: 13/700,271

(22) PCT Filed: Apr. 7, 2011
(86) PCT No.: PCT/EP2011/055400

§ 371 Date: Jan. 3, 2013

(30) Foreign Application Priority Data
Jun. 1, 2010 (EP) PCT/EP2010/057620

(51) Int. Cl. G06F 21/31

(52) U.S. Cl. CPC G06F 21/31
USPC 726/6

(57) ABSTRACT

A method of connecting a mobile station to a communications network is provided, and includes performing an authentication of the mobile station at the network. A secure identifier, generated at the mobile station, is received at a gateway node and at an access node from an authentication node of the network if it is determined by the authentication that the mobile station is a subscriber to the network. A first secure communications tunnel is established from the access node to the mobile station using a value of the secure identifier and a second secure communications tunnel is established from the access node to the gateway node of the network using the value of the secure identifier. The first and second communications tunnels are bound together to form a communications path between the mobile station and the network.

### FIELD OF THE INVENTION

The invention generally relates to a method of connecting a mobile station to a communications network. More particularly, the invention relates to a method for allowing a mobile station to establish a connection with and access a wireless communications network over an air interface.

### BACKGROUND OF THE INVENTION

Mobile (cellular) network operators operating wireless networks defined by the 3GPP standard are experiencing a massive growth in the use of mobile broadband data. Customers of the network operators are carrying a new generation of smart phones enhanced for the use of data services such as Web browsing, music and video streaming, access to email, and access to corporate networks.

A problem is that mobile networks based on cellular radio technology have a limited capacity for supporting the ever-increasing amount of mobile broadband data that they are required to handle. Recently discussed solutions to this problem include offloading the increasing data traffic from the cellular radio technology, which has limited capacity and is rather costly for standard broadband services, to Femtocells or approaches based on WLAN in unlicensed frequency bands.

In WLAN technology, current interworking solutions are either insecure, lack support for a reasonable business relation between the WLAN operator and the cellular operator, and/or are not compatible with the solutions specified in 3GPP. Furthermore, WLAN solutions are generally fully device based. There is either no relation between the cellular operator and the WLAN operator or infrastructure, or the devices do not offer any specific support.

Mobile network operators provide a set of credentials to allow their cellular subscribers to also access the operator's WLAN infrastructure. However, these solutions are considered quite inefficient due to the following:

Manual actions from the end user are typically required when accessing WLAN using the mobile network operator's infrastructure due to separate WLAN security credentials (like username/password compared to a SIM card for cellular access).

The operator is burdened with managing separate sets of security credentials for each access technology.

WLAN solutions do not provide any means of accessing operator services (such as those that can be reached exclusively through the operator's IP core network) via WLAN access, due to a lack of authentication and tunnelling procedures. Furthermore, they do not allow the network operator to control security when connecting to the WLAN access.

Femto solutions (Home NodeB networks) are similar to WLAN solutions for offloading traffic from the 3GPP network, in that they target deployment of customer premises equipment (CPE).

Such solutions, however, suffer from a major disadvantage that they operate in a licensed spectrum coming from the spectrum resources of the mobile network operator. The radio technology is the same as for the mobile operator's network. This creates numerous problems related to efficient spectrum usage between regular and Femto base stations (the CPE devices in the latter case), and Femto CPEs disturbing regular operation. Furthermore, due to the use of cellular radio technology, Femto-enabled CPE devices are typically much more expensive than common CPE devices that are only provided with WLAN radio technology.

Therefore an inexpensive, reliable and efficient solution is required, which allows traffic from a mobile station to be offloaded from a mobile network operator's network, while still allowing the mobile station to have access to services offered by the mobile network operator.

### SUMMARY OF THE INVENTION

Accordingly, the invention provides a method of connecting a mobile station to a communications network. The method includes performing an authentication of the mobile station at the network, receiving a secure identifier at a gateway node of the network and at an access node from an authentication node of the network if it is determined by the authentication that the mobile station is a subscriber to the network, generating the secure identifier at the mobile station if it is determined by the authentication that the mobile station is a subscriber to the network, establishing a first secure communications tunnel from the access node to the mobile station using a value of the secure identifier, establishing a second secure communications tunnel from the access node to the gateway node of the network using the value of the secure identifier, and binding together the first and second communications tunnels to form a communications path between the mobile station and the network.

In this case, a “subscriber” has a contractual relationship with the cellular operator and owns credentials to access the communications network, like a SIM card, soft sim, or username/password.

The mobile station may be a mobile phone, smart phone, laptop computer etc that is used by the subscriber and that accesses a cellular and/or a WLAN infrastructure for getting broadband data connectivity based on the subscriber's credentials.

Once the mobile station has been authenticated by the network (for example by an AAA server in the core network) as being a network subscriber, the network provides a secure identifier to the gateway node of the network and to an access node. The mobile station also generates this secure identifier after successful authentication. The value of the secure identifier is then used to establish a first secure communications tunnel from the access node to the mobile station and a second secure communications tunnel from the access node to the gateway node of the network. A secure communications path from the mobile station to the network is then formed by binding the first and second communications tunnels. The access node acts as a delegate for securing the mobile station accessing the network (the mobile network operator's core network and services). In particular, the access node provides security (IPSec security) in the name of the mobile station.

In this way, user traffic from the mobile station can be off-loaded from the network, while still ensuring access to services provided by the operator of the network. Existing solutions can then be re-used with minimal modifications; for example, no modification is required to the mobile station and only minimal modifications are required to the access node, such as a software upgrade. Furthermore, the user of the mobile station is not required to make any changes or manually enter authentication data, since authentication of the mobile station and access node is combined. This means that the invention provides an efficient and inexpensive method for offloading user traffic from the network.

Preferably, the first communications tunnel is established using a wireless encryption protocol over an air interface (for example a WLAN protocol such as WPA or WPA2) and the second communications tunnel is a secured IP tunnel (for example an IPSec tunnel). Since the first communications tunnel is secured over an air interface using a wireless protocol, this provides the advantage of a reduced processing power required by the mobile station. Furthermore, access to services provided by the operator of the network is possible using both the network operator's authentication credentials and existing WLAN access technology. The access node can then be just a simple, existing WLAN router. In this case, the subscriber may use the same subscription and also the same credentials to make use of the operator-provided or controlled WLAN access.

The secure identifier may be a first key, a second key, and/or a third key. The first key can be a temporary key, such as a master session key (MSK), received at the access node and gateway node from an authentication node of the network, for example an AAA server, then generated by the mobile station once it has been authenticated as being a subscriber station to the network. The second key may be provided by an operator of the network to the gateway node and the access node (for example at the time of installation) such that a value of the second key is predefined. Then the third key may be derived from a value of the first key and the value of the second key and provided to the access node and the gateway node.

There are three options for establishing the first and second secure communications tunnels. In a user-specific case, either both the first and second tunnels are established using the value of the first key, or the first tunnel is established using the value of the first key and the second tunnel is established using a value of the third key. Both the first and second secure communications tunnels are then specific to one particular (user of a) mobile station and can only be used for that mobile station. For a non user-specific case, the first tunnel can be established using the value of the first key and the second tunnel can be established using a value of the second key. This means that, once established, the second secure communications tunnel can be re-used for any mobile station or device requiring access to services through the gateway node. If the access node connects to more than one gateway node, a separate second communications tunnel is then required for connection of the access node to each gateway node.

Preferably, the value of the second key is stored in the access node and in the gateway node. The first key may be securely processed in the access node and gateway node. Optionally, the access node may receive IP configuration information, which it can then forward to the mobile station upon request of the mobile station. Advantageously, the network may provision the access node with additional configuration information for the mobile station, such as IP configuration information and traffic forwarding information, instead of directly provisioning the mobile station. The access node may act as a “DHCP proxy” entity to provision IP configuration information to the mobile station via regular DHCP operation.

The access node may also filter traffic from the mobile station in the access node to identify traffic intended for the network. This traffic identified by the filtering process may then be directed to the network. For example, the access node may be capable of directing traffic from the mobile station to the network, which could be a 3GPP network, for example, and to the Internet. The filtering step would filter out the traffic intended for the 3GPP network from the traffic intended for the Internet and direct only the filtered traffic to the 3GPP network.

The invention also provides a device for establishing a connection from a mobile station to a communications network. The device includes an access node, which has a transmit/receive unit for establishing a first secure communications tunnel from the access node to the mobile station using a value of the secure identifier. The device further includes a controller coupled with the transmit/receive unit for establishing a second secure communications tunnel from the access node to a gateway node of the network using the value of the secure identifier. The controller includes a receiver for receiving a secure identifier from an authentication node of the network if it is determined by the authentication node that the mobile station is a subscriber to the network. Furthermore, the controller is configured to bind together the first and second communications tunnels to form a communications path between the mobile station and the network.

The controller may either be located within the access node or outside the access node. In both cases, the controller will be coupled, either directly or indirectly, with the transmit/receive unit, for example a radio front end.

Preferably, the device further includes a secure processing module for processing the secure identifier. In this way, the device is secured against malicious software modifications by implementing a trusted computing environment. Trusted, tamper-proof storage hardware may also be provided for storing the secure identifier(s). A filter may also be provided for filtering out traffic from the mobile station intended for the network and directing the traffic towards the network through the second secure communications tunnel.

The invention further provides a gateway node for a communications network. The gateway node includes a transmit/receive unit for forwarding messages from a mobile station to an authentication node of the network, for performing an authentication of the mobile station at the network, and for receiving a secure identifier if it is determined by the authentication that the mobile station is a subscriber to the network. A storage medium is also provided for storing the secure identifier. The transmit/receive unit is adapted to establish a secure communications tunnel to an access node using the value of the secure identifier.

The invention therefore provides a solution having major simplifications for WLAN offload and interworking solutions. In particular the proposed solution does not require the installation of a 3GPP specific VPN client on the mobile station/terminal.

The invention will now be described, by way of example only, with reference to specific embodiments, and to the accompanying drawings, in which:

### BRIEF DESCRIPTION OF THE DRAWINGS

FIG. 1 is a simplified schematic diagram of a communications network in which a method according to an embodiment of the invention may be implemented;

FIG. 2 is a simplified schematic diagram of a device for establishing a connection from a mobile station to a communications network according to an embodiment of the invention; and

FIG. 3 is a schematic message flow diagram illustrating a method according to an embodiment of the invention.

### DETAILED DESCRIPTION OF EXEMPLARY EMBODIMENTS

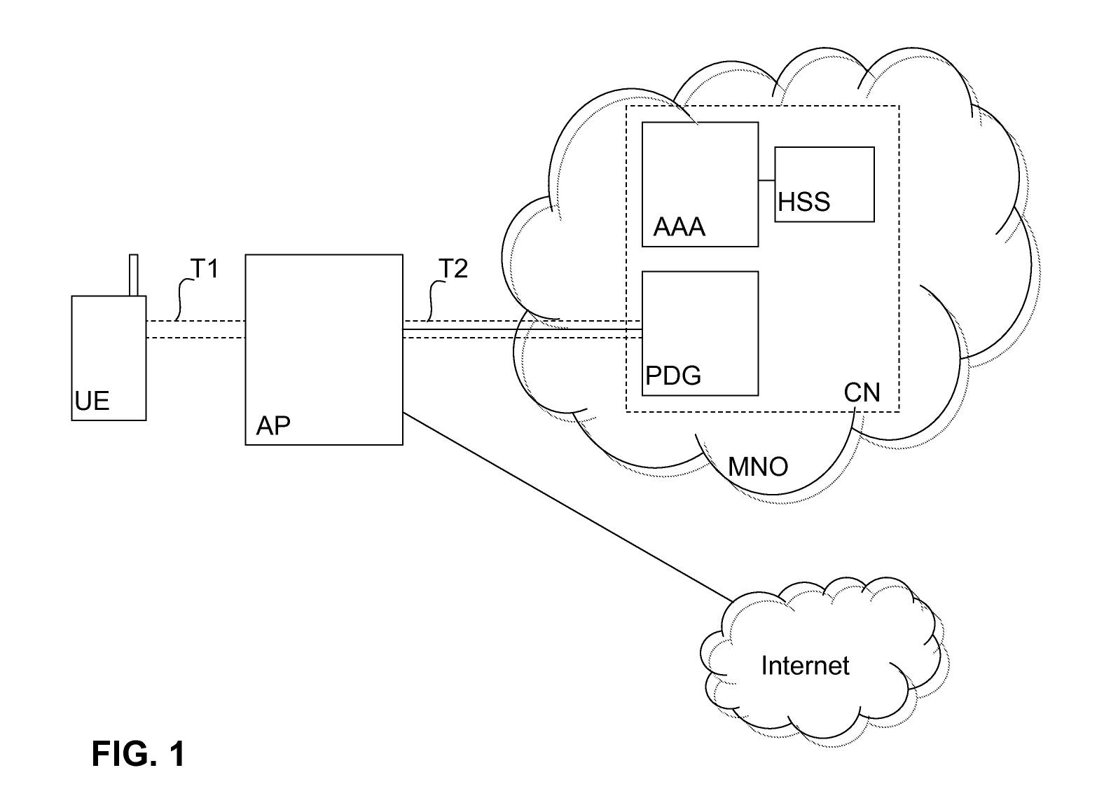

FIG. 1 shows a communications network accessible by a WLAN enabled mobile station UE (which can be any portable device such as a mobile telephone, a smart phone, laptop computer, etc) via an access point AP, which can be a WLAN router, for example.

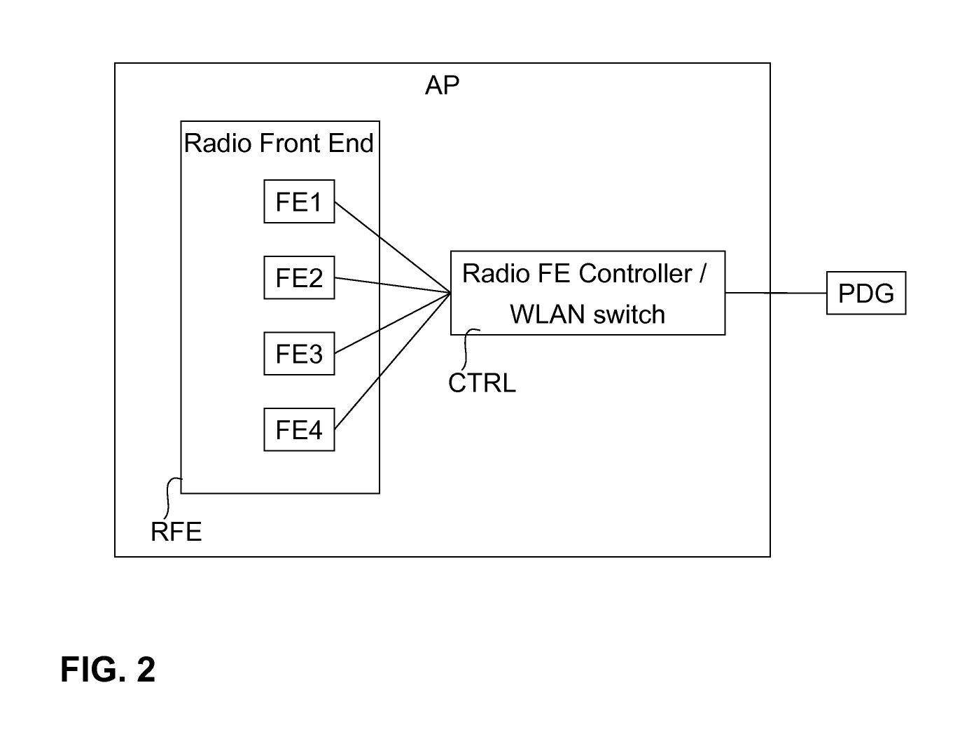

The access point AP is shown in FIG. 2 and includes a radio front end RFE having four parts FE1, FE2, FE3 and FE4 coupled to a controller CTRL, which may be a radio front end controller or a WLAN switch, for example. The access point AP is secured against malicious software modification and extraction of secret keys, etc. This can be achieved by ensuring software integrity, implementing a trusted computing environment within the access point AP, or storing secret keys and credentials in trusted tamper-proof hardware in the access point AP.

The radio front end RFE of the access point AP is adapted for establishing a secure communications tunnel T1 with the mobile station UE over an air interface and the controller CTRL is adapted for establishing a secure communications tunnel T2 with the core network part CN of a mobile network (e.g. a 3GPP network) belonging to a mobile network operator MNO and with the Internet. Such a communications tunnel is established via a packet data gateway PDG of the core network CN. The controller CTRL may also filter user traffic from the mobile station UE destined for the network MNO and direct that traffic to the network MNO.

The core network part CN of the mobile network MNO further includes an authentication server AAA coupled to a home subscriber server HSS. The home subscriber server HSS contains the home location register, which includes data relating to the users subscribing to the network MNO. This data can be used by the authentication server AAA to authenticate the mobile station UE when it requests to connect to the network MNO.

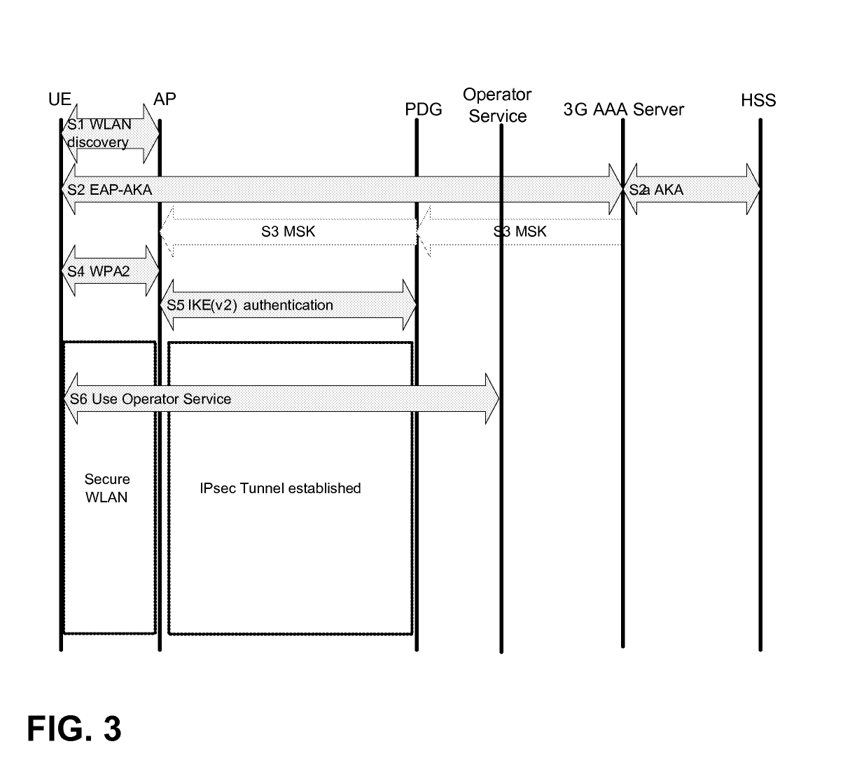

FIG. 3 illustrates how a connection between the mobile station UE and the mobile network MNO may be established using a method according to a first embodiment of the invention.

In step S1, the mobile station UE belonging to a subscriber of the network MNO discovers and selects the WLAN access point AP, which provides interworking or offload features as part of the subscription. This could be indicated by a dedicated SSID that is pre-configured in the mobile station UE, for example.

In step S2, the mobile station UE authenticates with the authentication server AAA server through the WLAN access point AP acting as an authenticator based on the EAP protocol and an appropriate EAP authentication method such as EAP-SIM or EAP-AKA. In step 2a, as an additional optional feature, the 3G authentication server AAA may interact with the home subscriber server HSS for authentication of the mobile station UE.

If authentication is successful; i.e., if it is determined by the authentication that the mobile station is a subscriber to the network, the 3G authentication server AAA generates an MSK key, which is sent in step S3 to the packet data gateway PDG and is also passed as part of an Access-Accept response to the access point AP.

In step S4, the mobile station UE and access point AP secure a WLAN radio link with common procedures, for example according to the WPA2-ENTERPRISE profile, by using the MSK key to form the first secure communications tunnel T1 over an air interface using a WLAN protocol.

In step S5, the access point AP establishes a second secure communications tunnel T2 with the packet data gateway PDG, which is an IPSec protected tunnel. The IPSec tunnel T2 is terminated at the controller CTRL in the access point AP. For establishing security and authentication, the access point AP and the packet data gateway PDG use the IKE or IKEv2 protocol with pre-shared key authentication. The pre-shared key is generated from the device-specific MSK and an authentication key apk that is pre-configured in the access point AP and in the packet data gateway PDG by the operator of the network MNO. The value of the authentication key apk is pre-defined by the operator of the network MNO. The packet data gateway PDG is required to allow the mobile network operator of the network MNO to authenticate that the access point AP is allowed to provide interworking or an offload functionality for traffic from the mobile station UE. The two keys MSK and apk then bind the IPsec tunnel T2 and the WLAN tunnel T1 to the specific device (the mobile station UE) and the access point AP.

In this embodiment, the preshared key psk used for IKE authentication can be computed by the following formula:

psk=HMAC−SHA256(MSK, apk, usage-data|UE-NAI),

where usage-data is a static text string and UE-NAI is the NAI used by the mobile station UE in the EAP authentication procedure.

In step S6, the mobile station UE can now make use of the IP connectivity provided by the binding of the IPSec tunnel T2 with the access point AP, WLAN secure tunnel T1 and mobile station UE and securely communicate through the packet data and access IP-based services provided by the operator of the network MNO.

In addition to the above-described method, IP configuration information of the mobile station UE (IP address, DNS server, standard gateway, etc.) may be sent in step S3 from the 3G authentication server AAA as part of the AAA authentication signaling with the access point AP (for example, signaling based on the RADIUS or Diameter protocol). For example, the AAA authentication signaling may carry IP configuration information by using additional data objects (attributes for RADIUS or AVPs for Diameter). Transfer of the IP configuration information as part of the AAA signaling allows for amendment by IP filter and forwarding rules to realize functions in the WLAN access point AP equivalent to the behavior known in 3GPP as LIPA and SIPTO.

Alternatively, the IP configuration information of the mobile station UE may be sent in step 5 from the packet data gateway PDG to the access point AP by using an IKE(v2) Configuration Payload. In this case, the access point AP then performs regular DHCP signaling with the mobile station UE and uses the received IP configuration parameters within the DHCP.

In a second embodiment of the invention, connection of a mobile station to the network MNO may be implemented by establishing an IPsec tunnel T2 between the access point AP and the packet data gateway PDG that does not depend on a specific device. This alternative method performs authentication of IKE(v2) without using the MSK key, so that no MSK key is used for establishing the tunnel T2 and the value of the psk key is set to that of the apk key. Once established, the IP-sec tunnel T2 can then be re-used for any device that requires access to data services provided by the network MNO through the packet data gateway PDG. The access point AP may also connect to more than one packet data gateway (for example if there are different operators for different devices using a single WLAN access point AP). In this case, there is a separate IPsec tunnel T2 for providing connection to each packet data gateway. This embodiment does not allow binding of each device to a specific IPsec tunnel but slightly reduces the overall number of IPsec tunnels per GW.

In larger WLAN networks, a potentially larger number of APs is controlled (and therefore logically grouped) by a central controller that is often called a WLAN-Switch. In a third embodiment, the functionality provided by the controller CTRL inside the access point AP (termination of the IPsec tunnel T2, for example) is performed by a WLAN-Switch node located outside the access point AP. In this case, all communication between the access point AP and the WLAN-Switch is sufficiently locally secured to avoid man-in-the-middle attacks.

Although the invention has been described hereinabove with reference to specific embodiments, it is not limited to these embodiments and no doubt further alternatives will occur to the skilled person, which lie within the scope of the invention as claimed.

1. A method of connecting a mobile station to a communications network, the method comprising:
performing an authentication of the mobile station at the network;
receiving a secure identifier at a gateway node of the network and at an access node from an authentication node of the network if it is determined by the authentication that the mobile station is a subscriber to the network;
generating the secure identifier at the mobile station if it is determined by the authentication that the mobile station is a subscriber to the network;
establishing a first secure communications tunnel from the access node to the mobile station using a value of the secure identifier;
establishing a second secure communications tunnel from the access node to the gateway node of the network using the value of the secure identifier; and
binding together the first and second communications tunnels to form a communications path between the mobile station and the network.

2. The method according to claim 1, wherein the first communications tunnel is established using a wireless encryption protocol over an air interface and the second communications tunnel is a secured IP tunnel.

3. The method according to claim 1, wherein the secure identifier is a first key.

4. The method according to claim 3, wherein the first secure communications tunnel is established using a value of the first key.

5. The method according to claim 4, further comprising providing a second key to the gateway node and the access node.

6. The method according to claim 5, wherein the second key is provided by an operator of the network and a value of the second key is predefined.

7. The method according to claim 5, wherein the second secure communications tunnel is established using the value of a second key.

8. The method according to claim 5, further comprising deriving a third key from a value of the first key and the value of the second key and providing the third key to the access node and the gateway node.

9. The method according to claim 8, wherein the second secure communications tunnel is established using the value of the third key.

10. The method according to claim 5, further comprising storing the value of the second key in the access node and in the gateway node.

11. The method according to claim 1, further comprising receiving IP configuration information at the access node and forwarding the information to the mobile station upon request of the mobile station.

12. The method according to claim 1, further comprising filtering traffic from the mobile station in the access node to identify traffic intended for the network and directing said traffic to the network.

13. A device for establishing a connection from a mobile station to a communications network, the device comprising:
an access node including
a receiver for receiving a secure identifier from an authentication node of the network if it is determined by the authentication node that the mobile station is a subscriber to the network, and
a transmit/receive unit for establishing a first secure communications tunnel from the access node to the mobile station using a value of the secure identifier; and
a controller coupled with the transmit/receive unit for establishing a second secure communications tunnel from the access node to a gateway node of the network using the value of the secure identifier, wherein the controller is configured to bind together the first and second communications tunnels to form a communications path between the mobile station and the network.

14. The device according to claim 13, wherein the controller is located within the access node.

15. The device according to claim 13, wherein the controller is located outside the access node.

16. The device according to claim 11, further comprising a secure processing module for processing the secure identifier.

17. The device according to any of claim 11, further comprising a filter for filtering out traffic in-tended for the network and directing said traffic towards the network through the second secure communications tunnel.

18. A gateway node for a communications network, the gateway node comprising:
a transmit/receive unit for forwarding messages from a mobile station to an authentication node of the network, for performing an authentication of the mobile station at the network, and for receiving a secure identifier if it is determined by the authentication that the mobile station is a subscriber to the network; and
a storage medium for storing the secure identifier,
wherein the transmit/receive unit is adapted to establish a secure communications tunnel to an access node using the value of the secure identifier.
